(19) United States
(12) Patent Application Publication
(10) Pub. No.: US 2026/0083202 A1
(43) Pub. Date: Mar. 26, 2026

(54) PROTECTION DEVICE

(71) Applicant: DAICEL CORPORATION, Osaka (JP)

(72) Inventor: Masayuki YAMAZAKI, Tokyo (JP)

(73) Assignee: DAICEL CORPORATION, Osaka (JP)

(21) Appl. No.: 19/406,995

(22) Filed: Dec. 3, 2025

Related U.S. Application Data
(63) Continuation of application No. PCT/JP2024/010767, filed on Mar. 19, 2024.

(30) Foreign Application Priority Data
Jun. 5, 2023 (JP) 2023-092696

(51) Int. Cl. A42B 3/04

(52) U.S. Cl. CPC A42B 3/0486

(57) ABSTRACT

A protection device including, a helmet configured to be mountable on a head of a wearer, an airbag housed in a folded state in the helmet prior to operation of the protection device; and an expansion source supplier configured to supply an expansion source to the airbag during operation of the protection device, in which the airbag is configured to cover from a posterior neck to both side neck portions of the wearer by expanding and inflating with the expansion source supplied from the expansion source supplier, and the protection device further includes an urging structure formed integrally with the airbag, and configured to urge the airbag toward at least one of the posterior neck or the side neck portions of the wearer by utilizing an expansion pressure of the airbag.

### CROSS-REFERENCE TO RELATED APPLICATIONS

The present application is a Continuation of International Patent Application No. PCT/JP2024/010767, filed on Mar. 19, 2024, which claims priority from Japanese Patent Application No. 2023-092696, filed on Jun. 5, 2023, the entire contents of each are incorporated herein by reference.

### TECHNICAL FIELD

The present invention relates to a protection device for protecting a head and a neck.

### BACKGROUND ART

In the related art, helmets have been widely known as protection devices for protecting the heads of riders of bicycles and the like; however, ordinary helmets do not have a function for protecting the cervical spine.

In this connection, airbag devices capable of protecting the neck of the person to be protected have also been proposed (see, for example, Patent Document 1).

Patent Document 1 discloses a technique in which an expandable airbag is housed inside the rear portion of a helmet, and the airbag is expanded by being supplied with pressurized gas stored in a storage chamber during operation, and thereby the airbag protects the neck of the wearer of the helmet.

### CITATION LIST

### Patent Document

Patent Document 1: JP 2022-525260 A

### SUMMARY OF INVENTION

### Technical Problem

Here, in the event of a fall off a bicycle, the impact may cause the head or neck to bend sharply mainly in the vicinity of the boundary between the neck and the head, resulting in damage to the neck in many cases. A known protection device may cover the neck of the wearer with the expanded airbag; however, the protection device may not be sufficient from the viewpoint of restricting the bending of the neck, or may not be very effective in protecting the neck from the damage due to excessive bending.

In view of the above circumstances, an object of the present disclosure is to provide a technique capable of suppressing excessive bending of a neck of a person to be protected.

### Solution to Problem

The present disclosure solves the above-described problems by the following aspects. Specifically, an overview of the technique according to the present disclosure is as follows.

### Aspect 1

To solve the above-mentioned problems, a technique according to the present disclosure is a protection device configured to protect a head and a neck of a wearer, the protection device including: a helmet configured to be mountable on a head of a wearer; a fixing strap configured to fix the helmet to the head; an airbag housed in a folded state in the helmet prior to operation of the protection device; and an expansion source supply unit configured to supply an expansion source to the airbag during operation of the protection device, in which the airbag is configured to cover from a posterior neck to both side neck portions of the wearer by expanding and inflating with the expansion source supplied from the expansion source supply unit, and the protection device further includes an urging member formed integrally with the airbag, and configured to urge the airbag toward at least one of the posterior neck or the side neck portions of the wearer by utilizing an expansion pressure of the airbag.

### Aspect 2

In the first aspect, the urging member may be stored on an interior side of the helmet prior to operation of the protection device, and pulled out to outside from the interior side of the helmet together with the airbag along with operation of the protection device.

### Aspect 3

In the first or second aspect, the urging member may include an urging strap including one end side connected to a front position in the helmet, the urging strap being configured to urge the airbag from a posterior neck side of the wearer toward a front side of the neck of the wearer during operation of the protection device.

### Aspect 4

In the third aspect, the urging strap may have elasticity.

### Aspect 5

In the third aspect, the urging strap may be fixed to an outer peripheral portion of the airbag.

### Aspect 6

In the third aspect, the helmet may be configured to cover at least an upper portion of an ear of the wearer in a state where the helmet is mounted on the head of the wearer.

### Aspect 7

In the first or second aspect, the urging member may include a shape holding member configured to hold a shape of the airbag having inflated during operation of the protection device and suppress deformation of the airbag in a direction away from the neck of the wearer.

### Aspect 8

In the seventh aspect, the shape holding member may be fixed to an outer peripheral portion of the airbag.

### Aspect 9

In the seventh aspect, the shape holding member may contain an elastic metal or a resin.

### Aspect 10

In the seventh aspect, prior to operation of the protection device, the shape holding member may be stored on an interior side of the helmet along an opening edge portion of the helmet, and pulled out to outside from the interior side of the helmet together with the airbag along with operation of the protection device.

### Aspect 11

In the seventh aspect, the urging member may further include an urging strap including one end side connected to a front position in the helmet, the urging strap being configured to urge the airbag from the posterior neck side of the wearer toward the front side of the neck of the wearer during operation of the protection device, and the other end side of the urging strap may be connected to the shape holding member.

### Aspect 12

In the first or second aspect, the protection device may further include an activation unit mounted on the helmet and configured to activate the expansion source supply unit, and the activation unit may include an operation condition detection sensor configured to detect a fact that a predetermined operation condition has been satisfied.

### Advantageous Effects of Invention

According to the present disclosure, it is possible to provide a technique capable of suppressing excessive bending of the neck of a person to be protected.

### BRIEF DESCRIPTION OF DRAWINGS

FIG. 1 is a diagram illustrating a protection device according to an embodiment.

FIG. 2 is a block diagram illustrating a schematic configuration of the protection device.

FIG. 3 is a diagram illustrating a configuration of a control unit.

FIG. 4 is a diagram illustrating an operating state of a protection device according to Embodiment 1.

FIG. 5 is an explanatory view illustrating a function of an urging strap and a shape holding member.

FIG. 6 is an explanatory view illustrating a first modification of the protection device.

FIG. 7 is a perspective view illustrating an operating state of a protection device according to a second modification.

FIG. 8 is a perspective view illustrating an operating state of a protection device according to a third modification.

FIG. 9 is a perspective view illustrating an operating state of a protection device according to a fourth modification.

### DESCRIPTION OF EMBODIMENTS

Hereinafter, a protection device according to an embodiment of the present disclosure will be described with reference to the drawings. Note that each of the configurations, combinations thereof, and the like in the embodiment is an example, and various additions, omissions, substitutions, and other changes of the configurations may be made as appropriate without departing from the spirit of the present disclosure. The present disclosure is not limited by the embodiment, and is limited only by the claims.

A protection device according to the present embodiment is configured to protect a head and a neck of a wearer, the protection device including: a helmet configured to be mountable on a head of a wearer; a fixing strap configured to fix the helmet to the head; an airbag housed in a folded state in the helmet prior to operation of the protection device; and an expansion source supply unit configured to supply an expansion source to the airbag during operation of the protection device, in which the airbag is configured to cover from a posterior neck to both side neck portions of the wearer by expanding and inflating with the expansion source supplied from the expansion source supply unit, and the protection device further includes an urging member formed integrally with the airbag, and configured to urge the airbag toward at least one of the posterior neck or the side neck portions of the wearer by utilizing an expansion pressure of the airbag.

### Embodiment

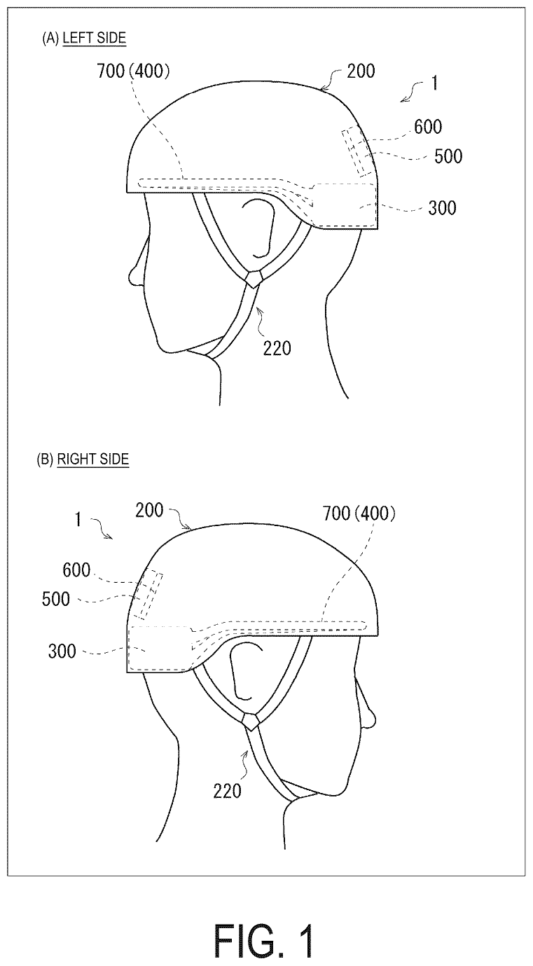

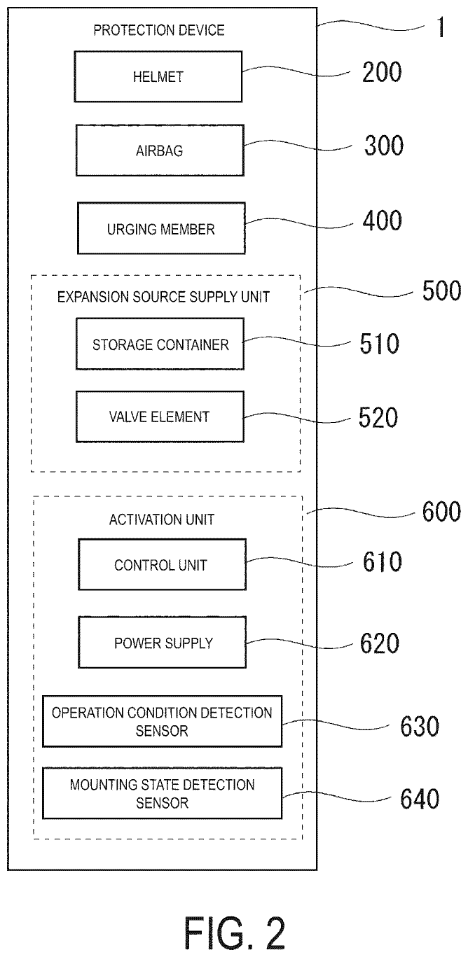

FIG. 1 is a diagram illustrating a protection device 1 according to an embodiment. FIG. 2 is a block diagram illustrating a schematic configuration of the protection device 1. The protection device 1 is a wearable type protection device to be worn by the person to be protected, and is a device for protecting the head and neck of the wearer (the person to be protected). The protection device 1 includes a helmet 200, which is a protector to be worn on the head of the wearer (the person to be protected) and to protect the head, an airbag 300, an urging member 400, an expansion source supply unit 500, and an activation unit 600. The protection device 1 is configured to protect the neck of the wearer (the person to be protected) by operating when a predetermined operation condition is satisfied. In this specification, the term “wearer” who wears the protection device 1 and the term “person to be protected” are used synonymously. In addition, in this specification, the term “neck” refers to a narrowed portion connecting the head and torso of a human body. A portion of the neck mainly located on the occipital portion side is referred to as the “posterior neck”. The “posterior neck” may be referred to also as the “nape portion”. A portion of the “neck” located on the front side, opposite to the “posterior neck”, is referred to as the “anterior neck”. The “anterior neck” may be referred to also as the “anterior throat portion”.

In FIG. 1, the upper section (A) is a perspective view of the helmet 200 as viewed from the left side, and the section (B) is a perspective view of the helmet 200 as viewed from the right side. In addition, FIG. 1 illustrates a state where the wearer is wearing (has mounted) the helmet 200. In addition, FIG. 1 illustrates a state before the protection device 1 is operated.

In the present embodiment, the helmet 200 is a half-type (substantially hemispherical) helmet. The helmet 200 includes a fixing strap 220 for fixing the helmet 200 to the wearer (the person to be protected). The helmet 200 itself may be a publicly known helmet, and an inner cushion (not illustrated in the drawing) for absorbing the impact in the event of a fall and the like may be provided inside the helmet 200. The inner cushion may be made of expanded polystyrene foam, such as expanded polystyrene (EPS) beads. The helmet 200 may be made of, for example, an acrylonitrile butadiene styrene (ABS) resin or a polycarbonate (PC) resin.

The fixing strap 220 is a so-called chin strap. The fixing strap 220 is a cord-like member for fixing the helmet 200 to the head of the wearer by being placed over the chin of the wearer. In the present embodiment, the mode of the fixing strap 220 is not particularly limited, and publicly known fixing straps may be used.

The airbag 300 is a bag member configured to expand and inflate when gas, which is an example of the expansion source, is supplied from the expansion source supply unit 500 during operation of the protection device 1. Prior to the operation of the protection device 1, the airbag 300 is housed in a folded state (specifically, contracted state) on the interior side of the helmet 200.

The expansion source supply unit 500 is activated by the activation unit 600. When the activation unit 600 activates the expansion source supply unit 500, supply of gas from the expansion source supply unit 500 to the airbag 300 is started, and accordingly the airbag 300 is expanded and inflated. For example, the expansion source supply unit 500 includes a storage container 510 that stores gas in a pressurized state for supply to the airbag 300, and a valve element 520 that closes a gas discharge port formed on the storage container 510.

Prior to the operation of the protection device 1 (prior to the activation of the expansion source supply unit 500), the storage container 510 is sealed with the valve element 520. Then, the sealing state of the storage container 510 is released when the valve element 520 is opened by the activation unit 600, and the pressurized gas stored inside the storage container 510 is discharged from the gas discharge port. The valve element 520 may be provided with an actuator not illustrated in the drawing, and the valve element 520 may be configured to open when the actuator is operated. Naturally, the activation mechanism that opens the valve element 520 of the storage container 510 is not particularly limited. For example, the valve element 520 may be composed of a thin metal plate member, and the activation unit 600 may open the valve element 520 by operating a rupture mechanism that ruptures the metal plate member making up the valve element 520. When the valve element 520 of the storage container 510 is opened, the gas discharge port of the storage container 510 and a gas introduction port of the airbag 300 communicate with each other, and gas is supplied to the airbag 300. The gas discharge port of the storage container 510 and the gas introduction port of the airbag 300 are connected via a conduit not illustrated in the drawing, and the gas discharged from the gas discharge port of the storage container 510 may be supplied to the airbag 300 through that conduit, for example.

While the configuration of the activation unit 600 is not particularly limited as long as the expansion source supply unit 500 can be activated, the activation unit 600 is composed of a control unit 610, a power source 620, an operation condition detection sensor 630, and a mounting state detection sensor 640 and the like, for example. The control unit 610 is a controller (control unit) that controls the actuator of the valve element 520, for example. The power source 620 is a power supply source that supplies power to the control unit 610, the operation condition detection sensor 630, the mounting state detection sensor 640 and the like, and may be a lithium ion battery or a dry cell, for example. When the actuator of the valve element 520 is operated with an operation command signal output from the control unit 610, the valve element 520 is opened. As a result, the expansion source supply unit 500 is activated, and gas is supplied from the expansion source supply unit 500 to the airbag 300.

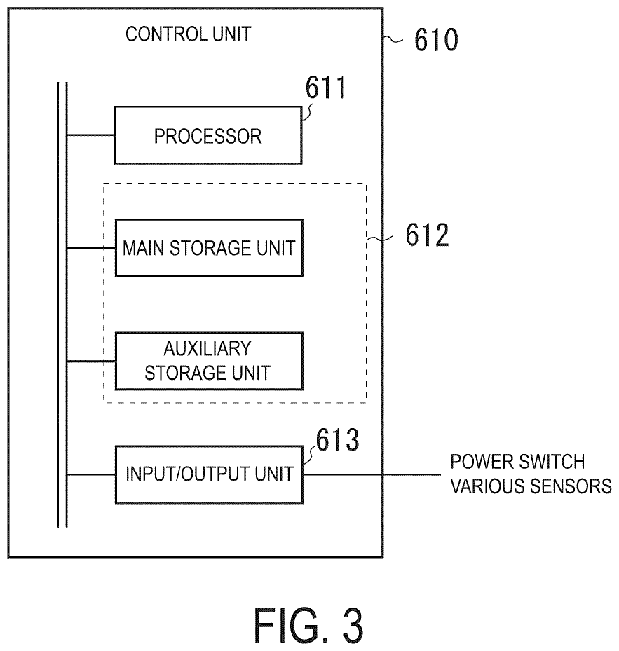

FIG. 3 is a diagram illustrating a configuration of the control unit 610. The control unit 610 includes a processor 611, a storage unit 612, and an input/output unit 613. The processor 611 integrally executes a variety of arithmetic processing in the control unit 610. The processor 611 may include an arithmetic processing unit such as a central processing unit (CPU), a digital signal processor (DSP), or a field-programmable gate array (FPGA).

The storage unit 612 includes a main storage unit and an auxiliary storage unit, for example. The main storage unit of the storage unit 612 includes a random access memory (RAM) or a read only memory (ROM), and caches information on programs and data used for arithmetic processing in the processor 611, for example. The main storage unit of the storage unit 612 may be formed integrally with the processor 611. The auxiliary storage unit of the storage unit 612 may be composed of a storage medium, for example, a volatile memory such as a RAM, a nonvolatile memory such as a ROM, or an erasable programmable ROM (EPROM). The auxiliary storage unit of the storage unit 612 stores an operating system (OS), various programs, various tables and the like for executing the operation of the protection device 1, for example. The input/output unit 613 is, for example, an interface that inputs information (detection results and the like) from various sensors such as the operation condition detection sensor 630 and the mounting state detection sensor 640, and outputs information (a control signal and the like) to various sensors or other devices. In addition, the protection device 1 includes a power switch not illustrated in the drawing, and a state signal of the power switch is also input to the input/output unit 613.

The operation condition detection sensor 630 is a sensor for detecting a fact that a predetermined operation condition has been satisfied. The predetermined operation condition is a condition for operating the protection device 1 (or may be referred to as a condition for activating the expansion source supply unit 500), such as a situation in which a bicycle ridden by the wearer of the helmet 200 falls off, or other conditions in which the wearer is exposed to danger, for example. The operation condition detection sensor 630 may be an acceleration sensor, or a gyro sensor (angular velocity sensor), for example. In addition, the operation condition detection sensor 630 may be a vital sensor that detects brain waves of the wearer. The vital sensor may detect brain waves different from those during normal conditions and thereby detect a hazardous state of the wearer. The vital sensor may be a contact-type sensor in contact with the head of the wearer, or a non contact-type sensor. The operation condition detection sensor 630 may include, for example, at least one of the above-described acceleration sensor, gyro sensor (angular velocity sensor), or vital sensor. Naturally, as the operation condition detection sensor 630, a combination of two or more types of sensors selected from the acceleration sensor, gyro sensor (angular velocity sensor), and vital sensor may be used. In addition, the operation condition detection sensor 630 is not particularly limited as long as the operation condition can be detected, and may be substituted by a detection device (such as a camera or a millimeter-wave radar) other than the sensors exemplified above. Since the protection device 1 includes the operation condition detection sensor 630, the activation unit 600 can operate the protection device 1 (activate the expansion source supply unit 500) at an appropriate timing.

The mounting state detection sensor 640 is a sensor that detects a contact state between the head of the wearer and the helmet 200. The mounting state detection sensor 640 may also be a pressure sensor, for example. The control unit 610 can determine whether the helmet 200 is being worn on the head on the basis of a detection signal of the mounting state detection sensor 640. A plurality of mounting state detection sensors 640 may be disposed inside the helmet 200, for example. In this case, the control unit 610 may determine that the helmet 200 is being worn when the detection signals from the plurality of mounting state detection sensors 640 indicate a contact state with the head.

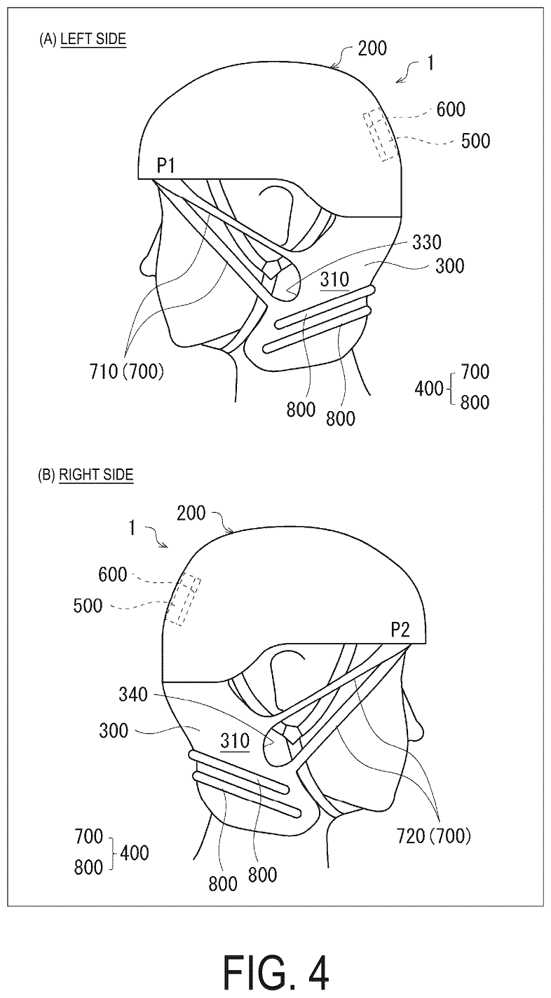

FIG. 4 is a diagram illustrating an operating state of the protection device 1 according to Embodiment 1. The upper section (A) is a perspective view of the helmet 200 as viewed from the left side, and the section (B) is a perspective view of the helmet 200 as viewed from the right side. During operation of the protection device 1, the airbag 300 to which gas is supplied from the expansion source supply unit 500 is drawn from the interior side of the helmet 200 to the outside in the process of expansion and inflation, and is brought into an inflated state to protect the occipital portion and neck of the wearer as illustrated in FIG. 4. In an inflated state, the airbag 300 has a substantially U-shape in its cross-section, and is configured to cover from the posterior neck to both the side neck portions of the wearer. The airbag 300 inflated through the operation of the protection device 1 covers the neck of the wearer, and thus protects the neck of the wearer. In addition, as illustrated in FIG. 4, the airbag 300 is configured to also cover and protect the occipital portion of the wearer in the inflated state.

The protection device 1 according to the present embodiment includes the urging member 400 formed integrally with the airbag 300 that expands and inflates when the expansion source supply unit 500 is activated. The urging member 400 is a member for urging the airbag 300 to at least one of the posterior neck or the side neck portions of the wearer by utilizing the expansion pressure of the airbag 300. In the present embodiment, prior to the operation of the protection device 1, the urging member 400 is stored on the interior side of the helmet 200, and pulled out to the outside from the interior side of the helmet 200 together with the airbag 300 along with the operation of the protection device 1.

In the present embodiment, the urging member 400 includes an urging strap 700 and a shape holding member 800. As illustrated in FIG. 4, the urging strap 700 is a cord-like member with one end side connected to front positions P1 and P2 in the helmet 200, and the other end side connected to the airbag 300. As illustrated in (A) and (B) of FIG. 4, the urging strap 700 is disposed on both the left and right sides of the helmet 200 along with the operation of the protection device 1. The strap disposed on the left side of the helmet 200 is referred to as a left urging strap 710, and the strap disposed on the right side of the helmet 200 is referred to as a right urging strap 720. The urging strap 700 is composed of the left urging strap 710 and the right urging strap 720. In the example illustrated in FIG. 4, two left urging straps 710 and two right urging straps 720 are disposed on the left and right sides of the helmet 200, respectively; however, the number of them is not particularly limited.

The reference numeral 330 indicated in (A) of FIG. 4 denotes a left front edge portion of the airbag 300. The reference numeral 340 indicated in (B) of FIG. 4 denotes a right front edge portion of the airbag 300. The left front side and right front side described herein mean directions with respect to the front-rear and left-right directions of the helmet 200 in the airbag 300 after the inflation. In the example illustrated in (A) of FIG. 4, one end of the left urging strap 710 is connected to the front position P1 in the helmet 200, and the other end is connected to the left front edge portion 330 of the airbag 300. The left urging strap 710 is configured to fit the left side of the face of the wearer during operation of the protection device 1, for example. In addition, in the example illustrated in (B) of FIG. 4, one end of the right urging strap 720 is connected to the front position P2 in the helmet 200, and the other end is connected to the right front edge portion 340 of the airbag 300. The right urging strap 720 is configured to fit the right side of the face of the wearer during operation of the protection device 1, for example.

Here, the material of the urging strap 700 (the left urging strap 710 and the right urging strap 720) is not particularly limited, but may be cloth, rubber, or wire for example. The urging strap 700 (the left urging strap 710 and the right urging strap 720) is configured to urge the airbag 300 from the posterior neck side of the wearer toward the front side of the neck of the wearer along with the operation of the protection device 1. Prior to the operation of the protection device 1, the urging strap 700 may be stored on the interior side of the helmet 200 along the inside of the side opening edge portion of the helmet 200, and is pulled out to the outside of the helmet 200 together with the airbag 300 along with the operation of the protection device 1.

Next, the shape holding member 800 is described. The shape holding member 800, which is configured to serve as a frame member fixed integrally to the airbag 300 for example, holds the shape of the inflated airbag 300 during operation of the protection device 1, and suppresses deformation of the airbag 300 in the direction away from the neck of the wearer. The shape holding member 800 is composed of an elastic metal or a resin, for example. In the example illustrated in FIG. 4, two shape holding members 800 formed into a substantially U-shape in a cross-sectional view are fixed along the lateral direction of the airbag 300. It should be noted that the number, position, shape and the like of the shape holding members 800 provided in the airbag 300 are not particularly limited. Note that prior to the operation of the protection device 1, the shape holding member 800 fixed integrally to the airbag 300 is stored on the interior side of the helmet 200 along the opening edge portion (for example, the rear opening edge portion) of the helmet 200. Further, the shape holding member 800 is pulled out to the outside of the helmet 200 together with the airbag 300 along with the operation of the protection device 1. Note that the shape holding member 800 may form a part of the outer shell of the helmet 200.

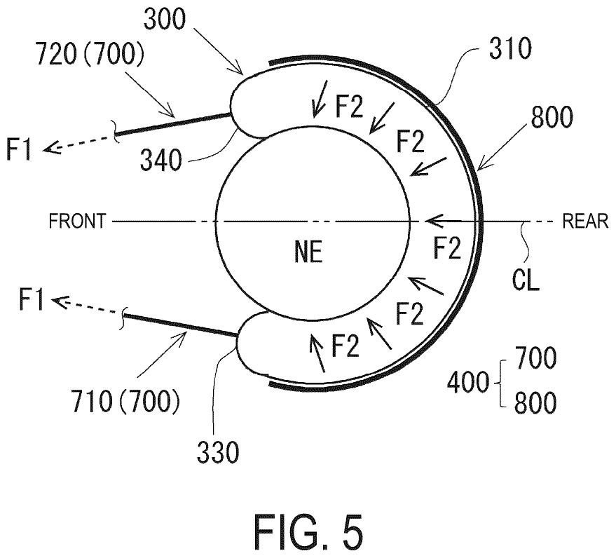

FIG. 5 is an explanatory view illustrating a function of the urging strap 700 (the left urging strap 710 and the right urging strap 720) and the shape holding member 800 as the urging member 400. FIG. 5 schematically illustrates a state where the urging strap 700 (the left urging strap 710 and the right urging strap 720) and the shape holding member 800 urge, toward the neck of the wearer, the inflated airbag 300 during operation of the protection device 1. More specifically, FIG. 5 schematically illustrates a cross-section of the urging member 400 and the airbag 300 after the inflation at the position of the neck of the wearer. Note that in FIG. 5, the reference numeral NE denotes the neck of the wearer.

First, a function of the urging strap 700 (the left urging strap 710 and the right urging strap 720) is described. As described with reference to FIG. 4, one end of the left urging strap 710 and one end of the right urging strap 720 are connected to the front positions P1 and P2 of the helmet 200, respectively, and the other ends thereof are connected to the left front edge portion 330 and the right front edge portion 340 of the airbag 300, respectively. In the present embodiment, the lengths of the left urging strap 710 and the right urging strap 720, and the positions (the front positions P1 and P2) where each one end thereof is attached to the helmet 200 are adjusted such that the expansion pressure of the airbag 300 acts on the left urging strap 710 and the right urging strap 720 in the expansion process (inflation process) of the airbag 300.

When the expansion pressure of the airbag 300 acts on the left urging strap 710 and the right urging strap 720, a tensile force that extends the left urging strap 710 and the right urging strap 720 along the axial direction is generated. When the expansion pressure of the expanded airbag 300 acts in a state where the one end of the left urging strap 710 and the one end of the right urging strap 720 are fixed to the front positions P1 and P2 of the helmet 200, the tensile force generated in the left urging strap 710 and the right urging strap 720 is transmitted to the airbag 300, thereby urging the airbag 300 toward the front side. In other words, the left urging strap 710 and the right urging strap 720 can urge the airbag 300 from the posterior neck side of the wearer toward the front side of the neck of the wearer. In this manner, the expanded airbag 300 can be maintained in close contact with the neck of the wearer (in particular, the posterior neck). As a result, the effect of restraining the neck of the wearer is increased, and the bending of the neck can be effectively suppressed. In this manner, the protection device 1 that is highly effective in protecting the neck from the damage due to excessive bending can be provided.

Further, the urging strap 700 (the left urging strap 710 and the right urging strap 720) preferably has elasticity. The urging strap 700 with such a configuration can urge the airbag 300 from the posterior neck side of the wearer toward the front side of the neck of the wearer with a greater urging force. As a result, during operation of the protection device 1, the restraining effect of restraining the neck of the wearer can be further increased.

Note that the broken arrows denoted by the reference numeral F1 in FIG. 5 represent an example of the direction of the urging force of the left urging strap 710 and the right urging strap 720 urging the airbag 300 during operation of the protection device 1. In addition, the reference numeral CL in FIG. 5 is a front-rear central axis passing through the center of the helmet 200 in the horizontal direction and extending in the front-rear direction. The front positions P1 and P2, where the one end of the left urging strap 710 and the one end of the right urging strap 720 are fixed to the helmet 200, may be set to positions closer to the front-rear central axis CL of the helmet 200 than the left front edge portion 330 and the right front edge portion 340 where the other end of the left urging strap 710 and the other end of the right urging strap 720 are fixed to the airbag 300. In this manner, the urging force denoted by the reference numeral F1 in FIG. 5 can be directed toward the front inner side of the helmet 200. The “inner side” described herein refers to the inner side in the horizontal direction of the helmet 200, and may also be referred to as the front-rear central axis CL side. In this manner, the expanded airbag 300 can be urged to come into close contact not only with the posterior neck of the wearer, but also with the left and right side neck portions of the wearer. That is, the airbag 300 can fit, in a U-shape, from the posterior neck to the left and right side neck portions of the wearer, and the restraining effect of restraining the neck of the wearer can be further increased.

Next, a function of the shape holding member 800 is described with reference to FIG. 5. As described above, the shape holding member 800 is formed as a frame member with a U-shape. In the mode illustrated in FIG. 5, the shape holding member 800 is fixed integrally along an outer peripheral portion 310 of the airbag 300. The outer peripheral portion 310 of the airbag 300 is a portion facing away from the side facing and contacting the neck of the wearer after inflation into a substantially U-shape. A portion of the airbag 300, which faces the neck of the wearer and covers the neck after inflation into a substantially U-shape, is referred to as “inner peripheral portion”. In fixing the shape holding member 800 to the outer peripheral portion 310 of the airbag 300, the shape holding member 800 may be disposed on the outer surface (surface exposed to the outside) side of the airbag 300, or the inner surface (surface on which gas is introduced) side of the airbag 300. It should be noted that the shape holding member 800 may be fixed along the inner peripheral portion of the airbag 300.

The expansion pressure of the airbag 300 during expansion (during inflation) acts on the shape holding member 800 disposed integrally with the airbag 300. Since the shape holding member 800 is formed as a frame member with a U-shape as described above, the shape holding member 800 functions to hold the shape of the inflated airbag 300 against the expansion pressure of the airbag 300, and suppresses deformation of the airbag 300 in the direction away from the neck of the wearer. Specifically, while the expansion pressure of the airbag 300 acts in the direction of pressing and extending the U-shape of the shape holding member 800, the shape holding member 800 urges the airbag 300 toward the neck (posterior neck and side neck portion) against the expansion pressure with its rigidity as a reactive force for the expansion pressure. The solid arrows denoted by the reference numeral F2 in FIG. 5 are an example of the direction of the urging force of the shape holding member 800 urging the airbag 300 during operation of the protection device 1.

With the above-described function of the shape holding member 800, the expanded airbag 300 can be maintained in close contact with the neck of the wearer (posterior neck and side neck portion). As a result, the effect of restraining the neck of the wearer is increased, and the bending of the neck can be effectively suppressed. In particular, in the mode illustrated in FIG. 5, since the shape holding member 800 is fixed integrally along the outer peripheral portion 310 of the airbag 300, the airbag 300 can be urged with a greater urging force toward the neck of the wearer during operation of the protection device 1, and thus the neck restraining effect with the airbag 300 can be further increased. That is, excessive bending of the neck of the wearer can be favorably suppressed. In addition, the shape holding member 800 may be composed of an elastic metal or a resin. In this manner, when the shape holding member 800 receives the expansion pressure of the airbag 300, a greater resilience is generated and the airbag 300 can be urged with a greater urging force toward the neck of the wearer.

As described above, the protection device 1 according to the present embodiment includes, in addition to the airbag 300 that protects the neck of the wearer, the urging member 400 (the urging strap 700 and the shape holding member 800) that urges the airbag 300 toward the neck. Thus, a gap is less likely to be formed between the expanded airbag 300 and the neck, and the neck can be favorably restrained. As a result, even when the wearer falls off during bicycle riding or in other event, excessive bending of the neck of the wearer due to the impact can be favorably suppressed, and the damage to the neck of the wearer can be favorably suppressed and reduced. Note that during operation, the protection device 1 does not need to completely restrict the movement of the head and neck of the wearer, and may restrain the neck with some allowance for movement. That is, the protection device 1 may allow for movement of the neck of the wearer to such an extent that prevents the neck from being damaged in the event of a fall or the like. In addition, the protection device 1 according to the present embodiment has a form in which the inflated airbag 300 does not cover the entire circumference of the neck of the wearer, but rather protects, in a U-shape, from the posterior neck to the both side neck portions, thereby preventing the throat of the wearer from being excessively constricted during operation of the protection device 1. In addition, in the protection device 1 according to the present embodiment, the one end side of the urging strap 700 that urges the airbag 300 toward the front side is fixed to the helmet 200, and the fixing strap 220 and the airbag 300 are not particularly coupled to each other, thereby preventing the throat of the wearer from being excessively constricted during operation of the protection device 1.

In addition, various modifications may be employed for the above-described protection device 1. Modifications of the protection device 1 are described below.

### First Modification

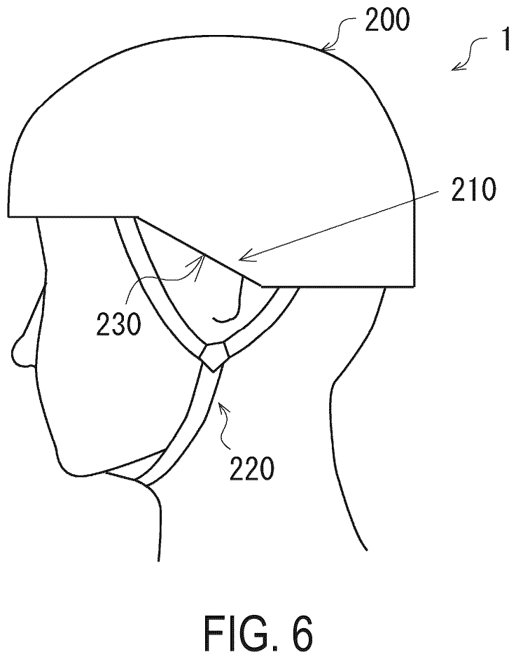

FIG. 6 is an explanatory view illustrating a first modification of the protection device 1. The helmet 200 according to the first modification is configured to cover at least an upper portion of the ear of a wearer in a state where the helmet 200 is mounted on the head of the wearer. Specifically, the helmet 200 according to the first modification includes an ear cover portion 210, and the ear cover portion 210 covers at least an upper portion of the ear of the wearer in a state where the helmet 200 is mounted on the head. Other structures are the same as those of the above-described protection device 1. Note that prior to the operation of the protection device 1, the urging strap 700 (the left urging strap 710 and the right urging strap 720) is stored inside the helmet 200 along the side opening edge portion denoted by the reference numeral 230. With the helmet 200 according to the first modification, the urging strap 700 (the left urging strap 710 and the right urging strap 720) is less likely to be caught by the ear of the wearer when the urging strap 700 is pulled out to the outside of the helmet 200 along with the airbag 300 that expands and inflates during operation of the protection device 1.

### Second Modification

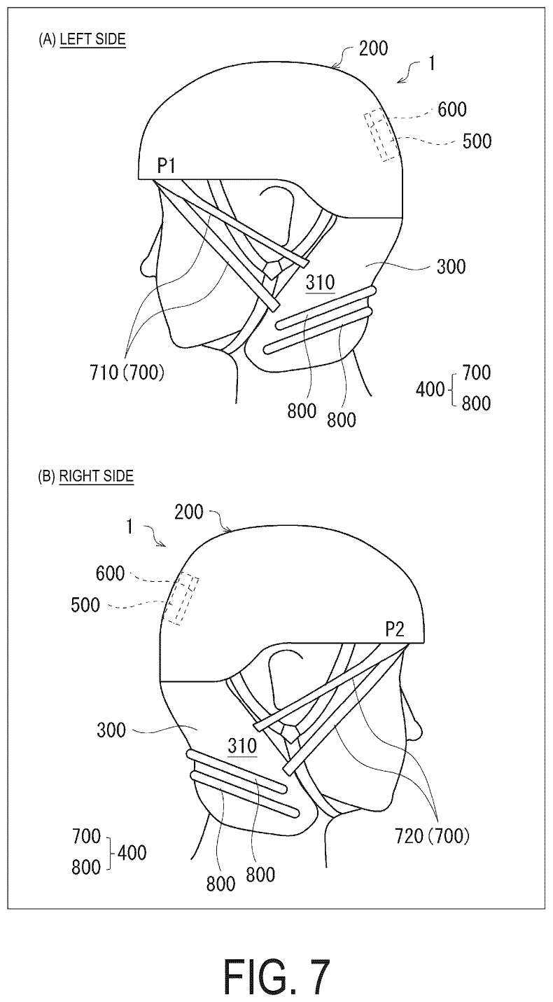

FIG. 7 is a perspective view illustrating an operating state of the protection device 1 according to a second modification. The upper section (A) is a perspective view of the helmet 200 as viewed from the left side, and the section (B) is a perspective view of the helmet 200 as viewed from the right side. In the second modification illustrated in FIG. 7, the urging strap 700 is fixed (connected) to the outer peripheral portion 310 of the airbag 300. That is, one end side of the urging straps 700 is connected to the front positions P1 and P2 in the helmet 200, and the other end side of the urging straps 700 (the left urging strap 710 and the right urging strap 720) is connected to the outer peripheral portion 310 of the airbag 300.

As illustrated in FIG. 7, the end portion of the urging strap 700 is fixed to the outer peripheral portion 310 of the airbag 300, and thus the urging force F1 described above with reference to FIG. 5 can be further directed toward the inner side of the helmet 200 (toward the front-rear central axis CL). As a result, the expanded airbag 300 can be further favorably brought into close contact with the left and right side neck portions of the wearer. That is, the airbag 300 can more favorably fit, in a U-shape, from the posterior neck to the left and right side neck portions of the wearer, and thus the restraining effect of restraining the neck of the wearer can be further increased. Note that in the modification illustrated in FIG. 7, the outer peripheral portion 310 of the airbag 300 may be encircled in its entirety in the circumferential direction by the urging strap 700 by connecting the end portions of the left urging strap 710 and the right urging strap 720 on the airbag 300 side. Even in such a mode, the urging strap 700 may be used in combination with the shape holding member 800.

### Third Modification

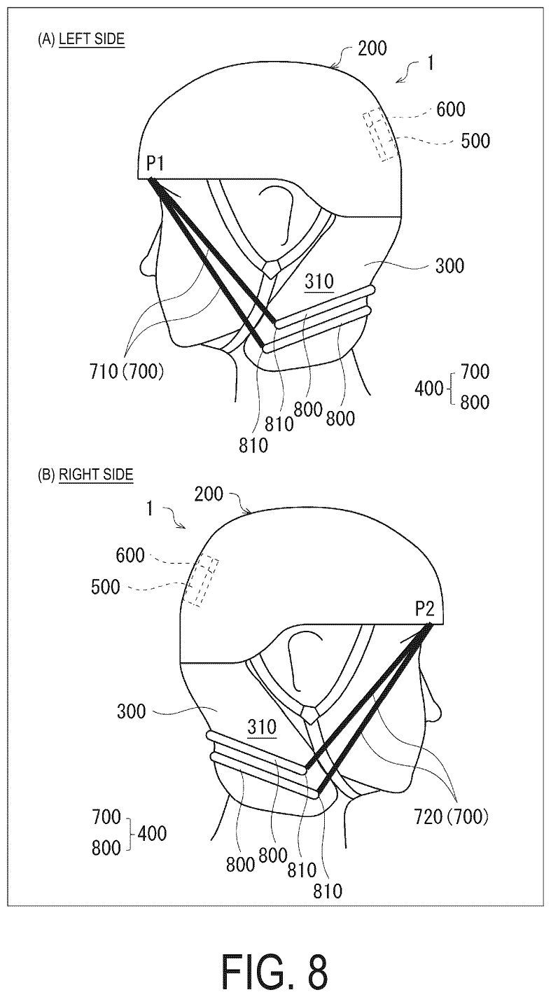

FIG. 8 is a perspective view illustrating an operating state of the protection device 1 according to a third modification. The upper section (A) is a perspective view of the helmet 200 as viewed from the left side, and the section (B) is a perspective view of the helmet 200 as viewed from the right side. In the third modification illustrated in FIG. 8, the other end side of the urging strap 700 (the left urging strap 710 and the right urging strap 720) is connected to the shape holding member 800. Note that this mode is the same as the above-described mode in that one end side of the urging straps 700 is connected to the front positions P1 and P2 in the helmet 200. In addition, in the example illustrated in FIG. 8, an end portion of the urging strap 700 is connected to an end portion 810 of the shape holding member 800 formed into a substantially U-shape.

According to the third modification, the end portion of the urging strap 700 is connected to the end portion 810 of the shape holding member 800 provided integrally with the airbag 300, and they are integrally coupled with one another. In this manner, during operation of the protection device 1, the shape holding member 800 provided integrally with the airbag 300 can be directly pulled toward the front side by the urging strap 700. That is, according to the third modification, the tensile force acting on the urging strap 700 can be directly transmitted to the shape holding member 800, and thus the airbag 300 can be further efficiently urged toward the posterior neck and side neck of the wearer. In this manner, the restraining effect of restraining the neck of the wearer is further increased, and the effect of protecting the neck is further improved.

Note that while in the above-described embodiment and modifications, the urging member 400 is described as including both the urging strap 700 (the left urging strap 710 and the right urging strap 720) and the shape holding member 800, this is not limitative, and the urging strap 700 and the shape holding member 800 may be used alone. Specifically, the urging member 400 of the protection device 1 may include only either the urging strap 700 or the shape holding member 800. In the case where either the urging strap 700 or the shape holding member 800 is used alone, in either case, the effect of restraining the neck can be obtained by urging the airbag 300 toward the neck of the wearer, utilizing the expansion pressure of the airbag 300 during operation of the protection device 1. Note that during operation of the protection device 1 (after the operation), the extending direction of the urging strap 700 (the left urging strap 710 and the right urging strap 720) (the direction in which the urging strap 700 is extended), the extending direction of the shape holding member 800, and their relative directions are not particularly limited, and the mode illustrated in FIG. 8 is merely an example.

### Fourth Modification

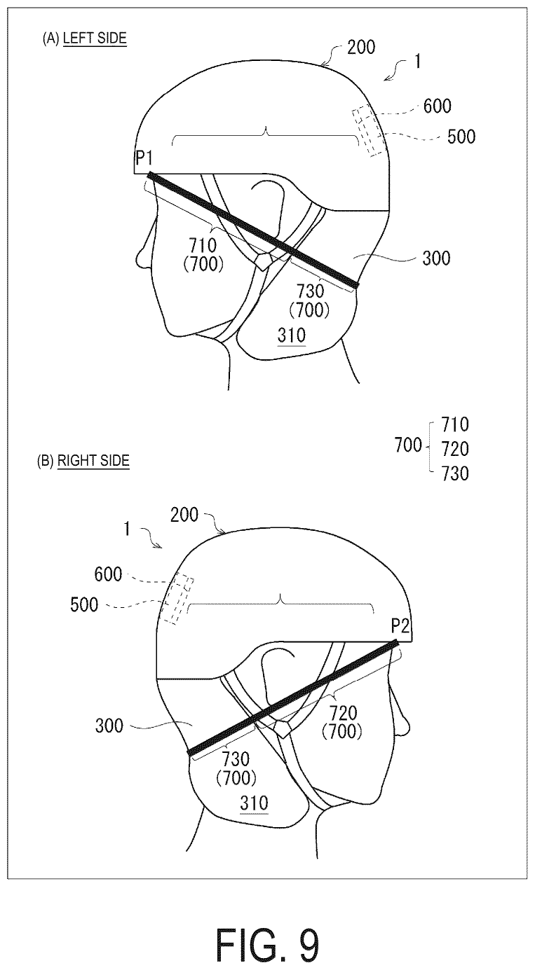

FIG. 9 is a perspective view illustrating an operating state of the protection device 1 according to a fourth modification. The upper section (A) is a perspective view of the helmet 200 as viewed from the left side, and the section (B) is a perspective view of the helmet 200 as viewed from the right side. The protection device 1 according to the fourth modification is provided with only the urging strap 700 (the left urging strap 710 and the right urging strap 720) as the urging member 400, and the shape holding member 800 is not provided in the airbag 300. In the fourth modification, an auxiliary strap 730 is integrally attached to an outer surface of the outer peripheral portion 310 of the airbag 300, and the auxiliary strap 730 extends around an outer peripheral portion 310. Then, both end portions of the auxiliary strap 730 are continuously coupled with the left urging strap 710 and the right urging strap 720. Specifically, the urging strap 700 can be regarded as a single continuous strap composed of the left urging strap 710, the auxiliary strap 730, and the right urging strap 720. Note that while the example illustrated in FIG. 9 illustrates a mode in which the protection device 1 includes the single continuous urging strap 700 composed of the left urging strap 710, the auxiliary strap 730, and the right urging strap 720, the number of the urging straps 700 is not particularly limited, and the protection device 1 may include two, or naturally, three or more urging straps 700.

The urging strap 700 having the above-mentioned configuration is configured such that both end portions are connected to the front positions P1 and P2 of the helmet 200, and the auxiliary strap 730 located in the middle portion is joined to the outer peripheral portion 310 of the airbag 300 and extends around the outer peripheral portion 310. This can increase the effect of urging the airbag 300 by the urging strap 700. That is, the airbag 300 can be urged with a greater urging force from the posterior neck side of the wearer toward the front side of the neck of the wearer, and the restraining effect of restraining the neck of the wearer during operation of the protection device 1 can be further increased.

Naturally, the protection device 1 may employ modes different from the above-described embodiment and modifications. For example, the mode is described above in which the activation unit 600 (the control unit 610) activates the expansion source supply unit 500 on the basis of the detection signal of the operation condition detection sensor 630 in the protection device 1 in the above-described embodiment, but a manual operation unit (not illustrated in the drawing) that is manually operated by a wearer may be provided in the helmet 200 such that the protection device 1 operates in response to a reception of an operation of the manual operation unit by the wearer, for example. For example, an appropriate mechanical mechanism (for example, a combination of mechanical elements such as a spring and a wire) may be interposed between the manual operation unit and the valve element 520 that seals the gas discharge port of the storage container 510 that stores pressurized gas such that the protection device 1 is operated by the wearer by operating the manual operation unit. While the specific structure of the manual operation unit is not particularly limited, it is possible to employ a structure in which a manual switch that can be operated by the wearer, a lock pin, and the like are provided in the helmet 200 such that the gas discharge port of the storage container 510 is opened when that manual operation unit is operated, for example.

In addition, the expansion source supply unit 500 may be a pyrotechnic gas generator used for inflating the airbag 300. While such gas generators are known in the art and detailed description thereof is omitted, the gas generator may include a housing that accommodates a gas generating agent therein, and a pyrotechnic igniter that operates upon supply of an operating current and ignites the gas generating agent inside the housing, and the expansion gas generated by combustion of the gas generating agent may be supplied to the airbag 300 through an appropriate conduit. In addition, while the mode of the protection device 1 in which the airbag 300 is stored in a folded state on the interior side of the helmet 200 prior to operation is described as an example, the airbag 300 may be stored in a location other than the interior of the helmet 200. For example, the airbag 300 covered with a cover may be attached to the outer shell of the helmet 200.

The embodiment of the present disclosure has been described above, and each of the aspects disclosed in the present specification can be combined with any other features disclosed therein.

### REFERENCE SIGNS LIST

1 Protection device
200 Helmet
220 Fixing strap
300 Airbag
400 Urging member
500 Expansion source supply unit
700 Urging strap
800 Shape holding member

1. A protection device, comprising:
a helmet configured to be mountable on a head of a wearer;
an airbag housed in a folded state in the helmet prior to operation of the protection device; and
an expansion source supplier to supply an expansion source to the airbag during operation of the protection device, wherein
the airbag is configured to cover from a posterior neck to both side neck portions of the wearer by expanding and inflating with the expansion source supplied from the expansion source supplier, and
the protection device further comprises an urging structure formed integrally with the airbag to urge the airbag toward at least one of the posterior neck or the side neck portions of the wearer by utilizing an expansion pressure of the airbag.

2. The protection device according to claim 1, wherein the urging structure is stored on an interior side of the helmet prior to operation of the protection device, and pulled out to outside from the interior side of the helmet together with the airbag along with operation of the protection device.

3. The protection device according to claim 1, wherein the urging structure includes an urging strap including one end side connected to the helmet, the urging strap being configured to urge the airbag from a posterior neck side of the wearer toward a front side of the neck of the wearer during operation of the protection device.

4. The protection device according to claim 3, wherein the urging strap has elasticity.

5. The protection device according to claim 3, wherein the urging strap is fixed to an outer peripheral portion of the airbag.

6. The protection device according to claim 3, wherein the helmet is configured to cover at least an upper portion of an ear of the wearer in a state where the helmet is mounted on the head of the wearer.

7. The protection device according to claim 1, wherein the urging structure includes a shape holding body to hold a shape of the airbag having inflated during operation of the protection device and suppress deformation of the airbag in a direction away from the neck of the wearer.

8. The protection device according to claim 7, wherein the shape holding body is fixed to an outer peripheral portion of the airbag.

9. The protection device according to claim 7, wherein the shape holding body contains an elastic metal or a resin.

10. The protection device according to claim 7, wherein prior to operation of the protection device, the shape holding body is stored on an interior side of the helmet along an opening edge portion of the helmet, and pulled out to outside from the interior side of the helmet together with the airbag along with operation of the protection device.

11. The protection device according to claim 7, wherein
the urging structure further includes an urging strap including one end side connected to a front position in the helmet, the urging strap being configured to urge the airbag from the posterior neck side of the wearer toward the front side of the neck of the wearer during operation of the protection device, and
the other end side of the urging strap is connected to the shape holding body.

12. The protection device according to claim 1, further comprising an activation structure mounted on the helmet to activate the expansion source supplier, wherein
the activation structure includes an operation condition detection sensor configured to detect a fact that a predetermined operation condition has been satisfied.

13. The protection device according to claim 3, wherein
the urging strap includes a left urging strap and a right urging strap,
the airbag includes an auxiliary strap extends around an outer peripheral portion thereof, both ends of the auxiliary strap, and
each of both ends of the auxiliary strap is connected to the left urging strap and the right urging strap, respectively.

14. The protection device according to claim 13, wherein
the urging strap is a single continuous strap including the left urging strap, the auxiliary strap, and the right urging strap.

15. The protection device according to claim 13, wherein
a front positions P1 and P2, where one end of the left urging strap and one end of the right urging strap are fixed to the helmet, is set to positions closer to a front-rear central axis CL of the helmet than a left front edge portion and a right front edge portion where the other end of the left urging strap and the other end of the right urging strap are fixed to the airbag.

16. The protection device according to claim 3, wherein
the urging strap is disposed on both left and right sides of the helmet.

17. The protection device according to claim 3, wherein
the urging strap has elasticity.
